(19) United States
(12) Patent Application Publication
(10) Pub. No.: US 2022/0343145 A1
(43) Pub. Date: Oct. 27, 2022

(54) METHOD AND SYSTEM FOR GRAPH NEURAL NETWORK ACCELERATION

(71) Applicant: Alibaba Singapore Holding Private Limited, Singapore (SG)

(72) Inventors: Fei XUE, Sunnyvale, CA (US); Yangjie ZHOU, Shanghai (CN); Hongzhong ZHENG, Los Gatos, CA (US)

(21) Appl. No.: 17/236,587

(22) Filed: Apr. 21, 2021

(51) Int. Cl. G06N 3/063; G06F 17/16

(52) U.S. Cl. CPC G06N 3/063; G06F 17/16

(57) ABSTRACT

This application describes a hardware accelerator, a computer system, and a method for accelerating Graph Neural Network (GNN) computations. The hardware accelerator comprises a matrix partitioning circuit configured to partition an adjacency matrix of an input graph for GNN computations into a plurality of sub-matrices; a sub-matrix reordering circuit configured to reorder rows and columns of the plurality of sub-matrices; a tile partitioning circuit configured to divide the plurality of sub-matrices with reordered rows and columns into a plurality of tiles based on processing granularities of one or more processors; and a tile distributing circuit configured to distribute the plurality of tiles to the one or more processors for performing the GNN computations.

### TECHNICAL FIELD

The disclosure relates generally to accelerating graph neural networks (GNNs) computations. More specifically, this disclosure relates to a hardware accelerator, a computer system, and a method for accelerating GNN computations using adjacency matrix reordering and partitioning.

### BACKGROUND

While traditional deep learning models are good at pattern recognition and data mining by capturing hidden patterns of Euclidean data (e.g., images, text, videos), Graph neural networks (GNNs) have shown to extend the power of machine learning to non-Euclidean domains represented as graphs with complex relationships and interdependencies between objects. Research has shown that GNNs can exceed state-of-the-art performance on applications ranging from molecular inference to community detection.

GNNs involve extensive matrix operations, such as computation-intensive matrix multiplications. Various optimizations have been proposed to boost the performance of GNN computations, such as graph partitioning and sampling methods. Graph partition is designed to partition one set of graph data into smaller sets of graph data to simplify graph analysis and computation. However, simply partitioning a large graph into smaller subgraphs does not fully exploit the potential of optimization and the resultant subgraphs are not guaranteed to be hardware-friendly. The sampling methods are proposed to replace adjacency matrix multiplication by a sampling process where the neighboring nodes are searched and gathered directly through graph metadata. However, searching neighboring nodes for each node during computation is costly and inefficient.

### SUMMARY

Various embodiments of the present specification may include hardware accelerators, systems, methods for accelerating GNN computations.

According to one aspect, a hardware accelerator for accelerating Graph Neural Network (GNN) computations is described. The hardware accelerator may include a matrix partitioning circuit configured to partition an adjacency matrix of an input graph for GNN computations into a plurality of sub-matrices; a sub-matrix reordering circuit configured to reorder rows and columns of the plurality of sub-matrices; a tile partitioning circuit configured to divide the plurality of sub-matrices with reordered rows and columns into a plurality of tiles based on processing granularities of one or more processors; and a tile distributing circuit configured to distribute the plurality of tiles to the one or more processors for performing the GNN computations.

In some embodiments, the sub-matrix reordering circuit is further configured to reorder the rows and the columns of the plurality of sub-matrices based on a number of non-zero values in each of the rows and the columns.

In some embodiments, the one or more processors for performing the GNN computations are configured in different computation modes optimized for processing data sets with different levels of sparsity.

In some embodiments, the one or more processors comprise a graphic processing unit (GPU).

In some embodiments, one of the different computation modes comprises a Compute Unified Device Architecture (CUDA) Sparse Matrix (cuSPARSE) library.

In some embodiments, one or more of the plurality of tiles have a size determined based on a warp size of the GPU.

In some embodiments, each of the plurality of tiles comprises a data set with a level of sparsity, and the tile distributing circuit is further configured to distribute each of the plurality of tiles to one of the one or more processors in a computation mode optimized for processing data sets with the level of sparsity.

In some embodiments, the input graph comprises a plurality of nodes with corresponding feature vectors, and the matrix partitioning circuit is further configured to partition the adjacency matrix based on distances among the feature vectors of the plurality of nodes in the input graph.

In some embodiments, the distances among the feature vectors comprise hamming distances among the feature vectors.

In some embodiments, the matrix partitioning circuit is further configured to: determine a number of sub-matrices to be partitioned from the adjacency matrix; determine a number of nodes m in each of the plurality of sub-matrices based on a total number of nodes in the input graph and the number of sub-matrices; and partition the adjacency matrix of the input graph into the plurality of sub-matrices each comprising m nodes.

In some embodiments, the matrix partitioning circuit is further configured to: select a node from the input graph; determine a plurality of feature similarity scores between the node and other nodes in the input graph; identify m−1 of the other nodes with highest feature similarity scores; and construct a sub-matrix based on rows of the adjacency matrix that correspond to the node and the m−1 nodes.

In some embodiments, the matrix partitioning circuit is further configured to remove the node and the m−1 nodes from the input graph prior to constructing another sub-matrix.

In some embodiments, the tile distributing circuit is further configured to: discard one of the plurality of tiles with a level of sparsity less than a non-zero threshold value.

According to another aspect, a computer system for accelerating Graph Neural Network (GNN) computations is described. The computer system may include an interconnect; one or more accelerators; one or more processors coupled to the one or more accelerators through the interconnect, the one or more accelerators configured to: partition an adjacency matrix of an input graph for GNN computations into a plurality of sub-matrices; reorder rows and columns of the plurality of sub-matrices; divide the plurality of sub-matrices with reordered rows and columns into a plurality of tiles based on data processing granularities of the one or more processors; and distribute the plurality of tiles though the interconnect to the one or more processors.

In some embodiments, the one or more accelerators are further configured to reorder the rows and the columns of the plurality of sub-matrices based on a number of non-zero values in each of the rows and the columns.

In some embodiments, the one or more processors are configured in different computation modes optimized for processing data sets with different levels of sparsity, and the one or more accelerators are further configured to: determine a level of sparsity of a data set in each of the plurality of tiles; and distribute the each tile to one of the one or more processors in a computation mode optimized for processing data sets with the level of sparsity.

In some embodiments, the one or more processors comprise a graphic processing unit (GPU), one of the different computation modes comprises a Compute Unified Device Architecture (CUDA) Sparse Matrix (cuSPARSE) library, and one or more of the plurality of tiles have a size determined based on a warp size of the GPU.

In some embodiments, the one or more accelerators are further configured to: determine a number of sub-matrices to be partitioned from the adjacency matrix; determine a number of nodes m in each of the plurality of sub-matrices based on a total number of nodes in the input graph and the number of sub-matrices; select a node from the input graph; determine a plurality of feature similarity scores between the node and other nodes in the input graph; identify m−1 of the other nodes with highest feature similarity scores; and construct a sub-matrix based on rows of the adjacency matrix that correspond to the node and the m−1 nodes.

In some embodiments, the one or more accelerators are further configured to discard one of the plurality of tiles with a level of sparsity less than a non-zero threshold value.

According to yet another aspect, a computer-implemented method for accelerating Graph Neural Network (GNN) computations is described. The method includes partitioning an adjacency matrix of an input graph for GNN computations into a plurality of sub-matrices; reordering rows and columns of the plurality of sub-matrices; dividing the plurality of sub-matrices with reordered rows and columns into a plurality of tiles based on processing granularities of one or more processors; and distributing the plurality of tiles to the one or more processors for performing the GNN computations.

Embodiments disclosed in the specification have one or more technical effects. In some embodiments, before performing GNN computations, the input graph represented as an input adjacency matrix may be preprocessed. The preprocessing may include partitioning the input adjacency matrix into sub-matrices and reordering rows and columns of the sub-matrices. This way, the input adjacency matrix may be partitioned into submatrices with different levels of data sparsity, which may be respectively assigned to different hardware processing units (e.g., processors) for optimized computations. For example, sparse submatrices (e.g., greater than 90% of sparsity) may be assigned to a hardware processing unit specifically optimized for sparse matrix multiplication. In some embodiments, the partitioned sub-matrices may be further partitioned into a plurality of tiles (units smaller than the sub-matrices) by considering the hardware parameters of the hardware processing units. The hardware parameters may include the data processing granularity in the hardware processing units. By aligning the size of the tiles with the data processing granularity of the underlying hardware processing unit, the described accelerator may further improve hardware resource utilization and thus the overall computing performance For example, a GPU may have a warp size (basic unit of execution) of 32 (each warp can support 32 threads). Accordingly, the sub-matrices may be split into 32*32 tiles so they can fit squarely in the warps in the GPU.

These and other features of the systems, methods, and hardware devices disclosed, and the methods of operation and functions of the related elements of structure and the combination of parts and economies of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates a schematic diagram of an exemplary hardware environment for implementing embodiments and features of the present disclosure.

FIG. 2A illustrates a schematic diagram of a hardware device for implementing hardware accelerators in accordance with some embodiments.

FIG. 2B illustrates an internal structure diagram of a graph preprocessing unit for accelerating GNN computations in accordance with some embodiments.

FIG. 3 illustrates exemplary graphic neural network (GNN) computations in accordance with some embodiments.

FIG. 4 illustrates an exemplary flowchart of preprocessing an input graph for GNN computations in accordance with some embodiments.

FIG. 5A illustrates an exemplary flowchart of partitioning and reordering an adjacency matrix in accordance with some embodiments.

FIG. 5B illustrates an example diagram of preprocessing an input graph for GNN computations in accordance with some embodiments.

FIG. 6 illustrates an exemplary method of accelerating GNN computations with adjacency matrix preprocessing in accordance with some embodiments.

FIG. 7 illustrates a block diagram of a computer system apparatus for accelerating GNN computation with adjacency matrix preprocessing in accordance with some embodiments.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

Graph Neural Network (GNN) has gained increasing popularity in various domains, including social networks, knowledge graphs, recommender systems, and even life science applications. At a high level, GNN involves computation on a graph structure G=(V, E) representing a graph (undirected or directed), where V denotes vertices, E denotes edges, and (V, E) may be denoted as the data set in the graph. In some embodiments, each of the nodes in the graph may be associated with a plurality of features. The graph may have different practical meanings depending on the use cases. For example, a GNN may mine the features of users on a social media network and thereby learning the relationships among the users. As another example, nano-scale molecules have an inherent graph-like structure with the ions or the atoms being the nodes and the bonds between them, edges. GNNs can be applied to learn about existing molecular structures and discover new chemical structures.

In the realm of GNNs, the data set in an input graph may be represented in an adjacency matrix. The elements of the matrix indicate whether pairs of vertices or nodes are adjacent/connected or not in the graph. The adjacency matrix is heavily used in GNN computations. For instance, training a GNN may follow a neighborhood aggregation scheme, where the feature vector (or another suitable representation vector) of a node is computed based on the adjacency matrix by recursively aggregating and transforming representation vectors of its neighboring nodes. The aggregation operations are computation-intensive and thus the performance bottleneck in GNN training. Empirical data shows aggregation operation takes about 50% to 90% of the entire training time.

The graph data set represented by a graph, in real-world applications, is often sparse and follows a power-law distribution. That is, in the corresponding adjacency matrix, rows and columns at the tail of the distribution contain elements mostly zeros, rows and columns at the majority of the distribution contain very few non-zero elements, and only a few rows and columns are filled with non-zero elements. Therefore, the aggregation operation involves matrix-matrix multiplication operations among sparse matrices. Since GNNs are usually adopted to learn latent relationships in complex and massive graph data (e.g., the number of nodes and edges may easily reach millions or even billions in social networks or molecules), it is practically impossible for human minds to perform these GNN computation (aggregation and transformation) on the data.

Meanwhile, hardware processing units may be configured to optimize the data processing (e.g., matrix operations) of data sets with different levels of sparsity. Here, the term “hardware processing units” may refer to one or more processors configured with a library specifically designed for optimizing computations based on data sets with different sparsity levels. For example, CUDA Sparse Matrix (cuSPARSE) library of NVIDIA may be used on Graphics Processing Units (GPUs) to provide a complete set of basic linear algebra subroutines for sparse matrices. Comparing with other processors designed for dense matrices, GPU with cuSPARSE shows performance gain when the data sparsity is greater than 90%. Therefore, to exploit the performance optimization of these hardware processing units in GNN computations, the adjacency matrix may be partitioned and rearranged to generate sub-matrices with different levels of sparsity. Each sub-matrix may subsequently be assigned to the hardware processing units optimized for processing data sets with that particular level of sparsity. In some embodiments, the sub-matrices may be further partitioned so that each data set (also called tile) has a size aligned with the data processing granularity of each hardware processing units. This way, the memory and computing resources within each hardware processing units may be fully utilized to further improve the performance of GNN computations.

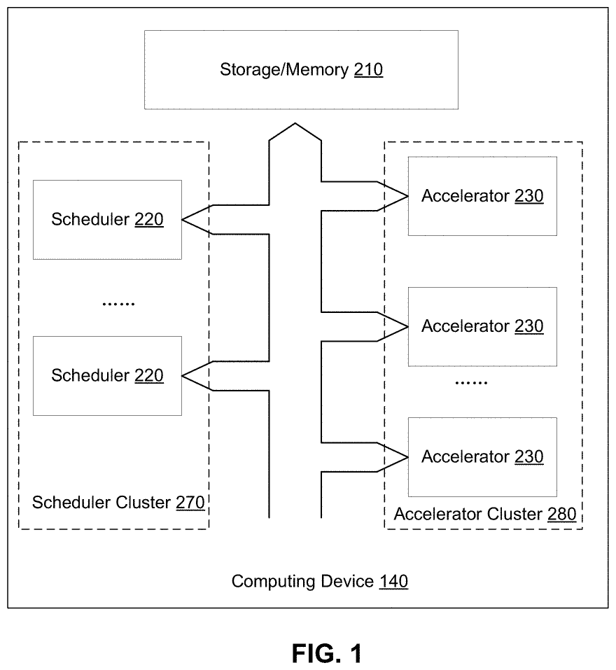

FIG. 1 illustrates a schematic diagram of an exemplary hardware environment for implementing embodiments and features of the present disclosure. The hardware environment in FIG. 1 includes a computing device 140 for illustrative purposes. Depending on the implementation, the computing device 140 may include fewer, more, or alternative components.

As shown, the computing device 140 includes a storage/memory 210 component connected to a scheduler cluster 270 and an accelerator cluster 280. The scheduler cluster 270 may contain multiple scheduler 220 and the accelerator cluster 280 may contain multiple accelerators 230. In some embodiments, the accelerator 230 may refer to a special processing unit designed to accelerate the processing speed of the neural network model at different stages (e.g., input data preprocessing, convolution operations, pooling operations, etc.). The accelerator may be embodied as a graphics processing unit (GPU), application-specific integrated circuit (ASIC), or field programmable gate array (FPGA), etc. to implement the logics for accelerating neural network operations. The scheduler 220 may refer to a processing unit that determines the scheduling of the accelerators 230, and distributes instructions and/or data to be executed to each accelerator 230. In some embodiments, the scheduler 220 may be implemented as Central Processing Unit (CPU), application-specific integrated circuit (ASIC), field programmable gate array (FPGA), or other suitable forms.

In comparison, the traditional CPU architecture allocates its majority of resources to the control unit and storage unit, while the computing unit is often under-resourced. While CPU is very effective in the logical control aspect, it is not efficient in the large-scale parallel computing. Therefore, various hardware accelerators have been developed to improve the processing speed of computation for different functions and different fields. The hardware accelerator proposed in the present specification includes a processing unit dedicated to accelerating the performance of GNN computations. It is a data-driven parallel computing architecture dealing with a large volume of operations, such as graph partitioning, row/column reordering, hardware-granularity-aware matrix partitioning, convolution, pooling, another suitable operation, or any combination thereof. The data and intermediate results of these operations may be closely related to each other in the whole GNN process, and will be frequently used. Without the accelerators, the existing CPU framework with small memory capacities in the core of the CPU will lead to a large number of frequent memory accesses to the outside storage/memory (e.g., outside of the CPU). These memory accesses are costly and will cause low processing efficiency. With the accelerators, which is dedicated to accelerating the data processing speed of GNNs, can greatly improve the processing efficiency and computing performance for at least following reasons: (1) the input data (graph) may be partitioned into a plurality of sub-matrices to cluster similar nodes (with similar feature vectors), (2) the rows and columns of each sub-matrix may be reordered to cluster data with similar levels of sparsity, and (3) each sub-matrix may be further partitioned into smaller units called tiles based on data processing granularities of the underlying processors performing the GNN computations (convolution, aggregation, transformation, polling, etc.). Since the tiles are carefully sized to fit underlying processors, the on-chip memory in each processor may be utilized in the GNN computations and frequent memory access to the off-chip memory may be avoided.

In some embodiments, the storage/memory 210 may store various neural network models (e.g., the nodes of these models and the weight or parameters of these nodes) and input data to these models (e.g., input graphs to GNNs, such as nodes, feature vectors of the nodes, edges, etc.). The accelerator 230 in this specification may perform preprocessing of the input data to the models to accelerate the subsequent neural network computations. For example, a scheduler 220 may send the address of an input graph within the storage/memory 210 to an accelerator 230 in the form of instructions. The accelerator may subsequently (e.g., at a scheduled point in time) locate and fetch the input data directly from the storage/memory 210 and temporarily store them in its on-chip memory for preprocessing the input data. The output of the preprocessing may include a plurality of tiles of data with different levels of sparsity. In some embodiments, these tiles may be distributed to a plurality of underlying processors for accelerated computation. Different underlying processors may be optimized to perform neural network computations on data sets with different levels of sparsity. Distributing the tiles to the underlying processors may include assigning each tile to one underlying processor optimized to process data sets with the sparsity level of the data set in the each tile. The outputs of the underlying processors may be aggregated to generate the final computation result. In some embodiments, these underlying processors may be implemented as a part of or separately from the accelerator 230. If the underlying processors are implemented as part of the accelerators 230, the schedulers 220 may send the addresses of the parameters of the corresponding neural network model in storage/memory 210 to the accelerator 230 in the form of instructions. The accelerator 230 may subsequently locate these parameters (such as weights) directly in storage/memory 210 and temporarily store them in its on-chip memory for the underlying processors to perform the computations based on the above-mentioned tiles.

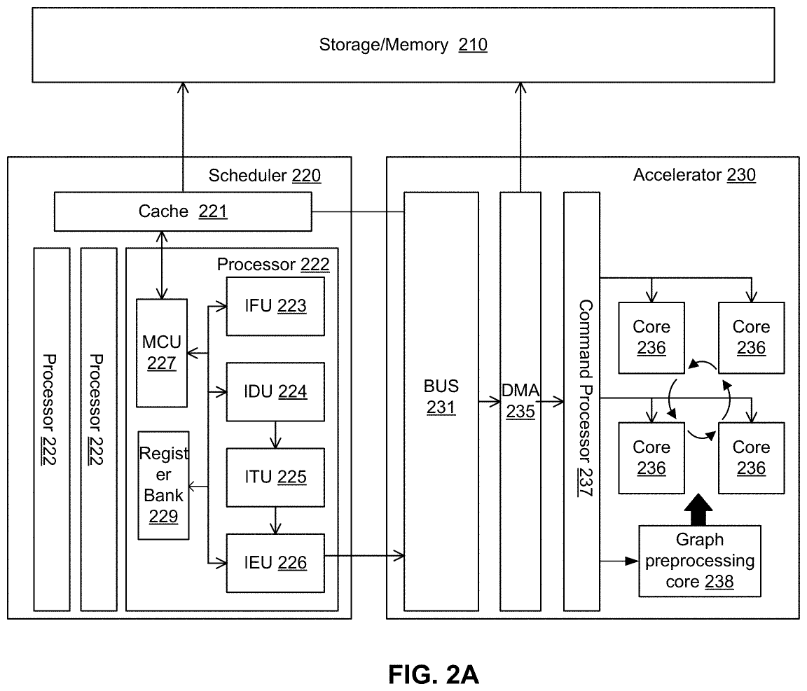

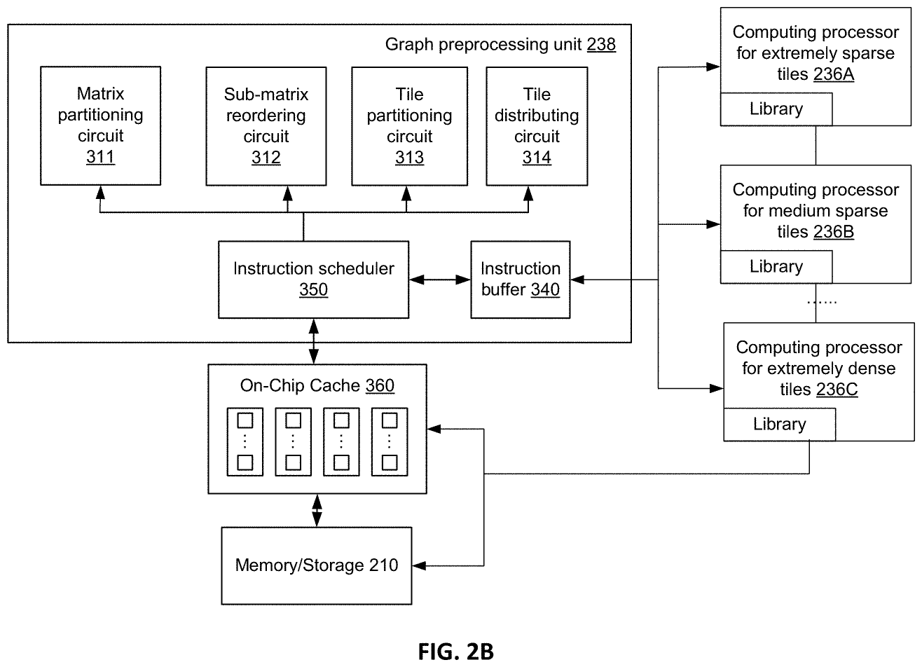

FIG. 2A illustrates a schematic diagram of a hardware device for implementing hardware accelerators in accordance with some embodiments. The hardware device in FIG. 2A illustrates the internal structures of a scheduler 220 and an accelerator 230 in FIG. 1, as well as the data/instruction flow among the scheduler 220, the accelerator 230, and the storage/memory 210.

As shown in FIG. 2, the scheduler 220 may include multiple processor 222 and a cache 221 shared by the multiple processors 222. Each processor 222 may include an instruction fetching unit (IFU) 203, an instruction decoding unit (IDU) 224, an instruction transmitting unit (ITU) 225, and an instruction execution unit (IEU) 226.

In some embodiments, the IFU 223 may fetch to-be-executed instructions or data from the storage/memory 210 to an register bank 229. After obtaining the instructions or data, the scheduler 220 enters an instruction decoding stage. The IDU 224 decodes the obtained instruction according to a predetermined instruction format to determine operand(s) acquisition information, where the operands are required to execute the obtained instruction. In some embodiments, the operand(s) acquisition information may include pointers or addresses of immediate data, registers, or other software/hardware that provide the operand(s).

In some embodiments, the ITU 225 may be configured between the IDU 224 and the IEU 226 for instruction scheduling and management. It may efficiently allocate instructions to different IEUs 226 for parallel processing.

In some embodiments, after the ITU 225 allocates an instruction to one IEU 226, the IEU 226 may execute the instruction. However, if the IEU 226 determines that the instruction should be executed by the an accelerator 230, it may forward the instruction to the corresponding accelerator 230 for execution. For example, if the instruction is directed to GNN computation based on an input graph, the IEU 226 may send the instruction to the accelerator 230 via the bus 231 for the accelerator 230 to execute the instruction.

In some embodiments, the accelerator 230 may include multiple cores 236 (4 cores are shown in FIG. 2A, but those skilled in the art may appreciate that the accelerator 230 may also include other numbers of cores 236), a command processor 237, and direct storage access (DMA) interface 235, and bus channel 231.

The bus channel 231 may include a channel through which instructions/data enter and exit the accelerator 230. The DMA interface 235 may refer to a function provided by some computer bus architectures, which enables devices to directly read data from and/or write data to the memory 210. Compared with the method in which all data transmission between devices passes through the scheduler 220, the architecture illustrated in FIG. 2A greatly improves the efficiency of data access. For instance, the core of the accelerator 230 may directly access the memory 210 and read the parameters of a neural network model (for example, the weight of each node) and/or input data.

The command processor 237 may be configured to allocate the instructions sent by the scheduler 220 via the IEU 226 to the accelerator 230 to the cores 236 for execution. After the to-be-executed instructions enter the accelerator 230 from the bus channel 231, they may be cached in the command processor 237, and the command processor 237 may select the cores 236 and allocates the instructions to the cores 236 for execution. In addition, the command processor 237 may be also responsible for the synchronization operation among the cores 236.

In some embodiments, the instruction allocated by the command processor 237 may include preprocessing an input graph for accelerating GNN computations. The instruction may be sent to a graph preprocessing core 238 to perform the preprocessing. In some embodiments, the input graph may be directly located and fetched from the storage/memory 210 through the DMA interface 235. In some embodiments, the input graph may be represented as an adjacency matrix. Each node in the input graph may correspond to a row and a column in the adjacency matrix, and the features of each node may be represented as a feature vector in the adjacency matrix.

FIG. 2B illustrates an internal structure diagram of a graph preprocessing unit 238 for accelerating GNN computations in accordance with some embodiments. The graph preprocessing unit 238 may be implemented as a graph preprocessing core 238 or as a part of the graph preprocessing core 238 in FIG. 2A. A hardware GNN accelerator may include one or more graph preprocessing units 238 illustrated in FIG. 2B. Depending on implementations, the graph preprocessing unit 238 may include more, fewer, or alternative components or circuits.

In some embodiments, as shown in FIG. 2B, the graph preprocessing unit 238 may include a matrix partitioning circuit 311, a sub-matrix reordering circuit 312, a tile partitioning circuit 313, a tile distributing circuit 314, an instruction scheduler 350, an instruction buffer 340. The graph preprocessing unit 238 may be electronically connected with an on-chip cache bank 360, and a memory/storage 210. Here, the term “circuit” refers to a electronic circuit comprising individual electronic components, such as resistors, transistors, capacitors, inductors, and diodes, connected by conductive wires or traces through which electric current can flow. Although the circuits 311-314 are illustrated in FIG. 2B as a part of one processing unit 238, they may be implemented as separate hardware devices or in different cores. The graph preprocessing unit 238 and the on-chip cache 360 may be implemented in a same accelerator and/or on the same die.

In some embodiments, the instruction sequence allocated by the command processor 237 (in FIG. 2A) to the graph preprocessing unit 238 may first be cached in the instruction buffer 340. Then, the instruction scheduler 350 may fetch instructions from the instruction buffer 340 in a first-in-first-out order, and allocate them to the matrix partitioning circuit 311, the sub-matrix reordering circuit 312, the tile partitioning circuit 313, and the tile distributing circuit 314 for execution according to the instructions. Some instructions may include addresses of data stored in the on-chip memory 360 for the circuitry 311-314 to fetch.

In some embodiments, the matrix partitioning circuit 311 may be configured to partition an adjacency matrix of an input graph for GNN computations into a plurality of sub-matrices. In some embodiments, the partitioning of the adjacency matrix is based on the similarities among the nodes in the input graph. The similarity between every two nodes may be determined by a distance (Hamming distance) between the feature vectors of the two nodes. The output of the matrix partitioning circuit 311 may include a coarse-grained partition of the original adjacency matrix so each sub-matrix includes similar feature vectors.

In some embodiments, the sub-matrix reordering circuit 312 may be configured to reorder rows and columns of the plurality of sub-matrices. For example, the output of the matrix partitioning circuit 311 may be fed into the sub-matrix reordering circuit 312 for reordering the rows and columns of each sub-based on the number of non-zero values in each row and each column. The output of the sub-matrix reordering circuit 312 may include a fine-grained partition of the original adjacency matrix to co-locate the non-zero values in the sub-matrices.

In some embodiments, the tile partitioning circuit 313 may be configured to further partition the output of the sub-matrix reordering circuit 312 (e.g., the sub-matrices with co-located non-zero values) into smaller units called tiles. The partitioning that occurred in the tile partitioning circuit 313 may be based on the data processing granularity of the computing processors 236A-236C. The data processing granularity here refers to the parallel processing capacity (e.g., the number of threads that can be parallelly processed, the number of cores within each processor 236, etc.) of the computing processors 236A-236C. Each tile generated by the tile partitioning circuit 313 may fit into each computing processor to fully utilize the parallel processing capacity and minimize unnecessary/expensive memory accesses. For example, a typical warp in a GPU supports 32 threads, and thus a tile to be allocated to GPU may have a size of 32 by 32. That is, the tile's dimensions may be configured to be the same as the number of threads supported by each warp in the GPU.

In some embodiments, since the tiles are partitioned from the sub-matrices with co-located non-zeros, each tile may include a data set of a sparsity level. As described above, the computing processors 236A-236C may be optimized to process data with a specific data sparsity level by deploying libraries. For instance, CUDA Sparse Matrix (cuSPARSE) library for GPU is the best fit for processing data sets with a sparsity of over 90%, while CUDA Basic Linear Algebra Subprograms (cuBLAS) library for GPU may be applied to dense data sets. In some embodiments, the tile distributing circuit 314 may be configured to distribute the plurality of tiles to the computing processors 236A-236C. Each tile with a data sparsity level may be allocated to a computing processor equipped with a library optimized for processing data with the same data sparsity level. For example, extremely sparse tiles may be allocated to the computing processor 236A for processing, medium sparse tiles may be allocated to computing processor 236B for processing, and extremely dense tiles may be allocated to computing processor 236C for processing. The classification of the data sparsity levels of the tiles may be determined based on a set of thresholds, such as a tile with more than 90% of non-zeros may be classified as extremely dense, a tile with more than 90% of zeros may be classified as extremely sparse.

In some cases, if the sparsity level of the data set within a tile is below a non-zero threshold value (e.g., 1%), the tile may be discarded and not sent to any of computing processors 236A-236C. The threshold value may be determined based on machine learning algorithms to find an optimal tradeoff balance between computation efficiency and loss of accuracy.

In some embodiments, the original adjacency matrix, the sub-matrices, the tiles, other input or intermediate data may be stored in the on-chip memory 360. Distributing the tiles may include fetching the tiles from the on-chip memory 360.

In some embodiments, the memory/storage 210 may store neural network parameters, constants, or hyper-parameters, such as the number of sub-matrices to be partitioned from an input graph, a threshold value to filter out over-sparse tiles (e.g., tiles with sparsity levels below a threshold value will be discarded and not distributed to the computing processors for processing), another suitable constant, or any combination thereof.

In some embodiments, the computation results generated by the computing processors 236A-236C may be fed back to the on-chip cache 360 or the memory/storage 210 for the next round of computation.

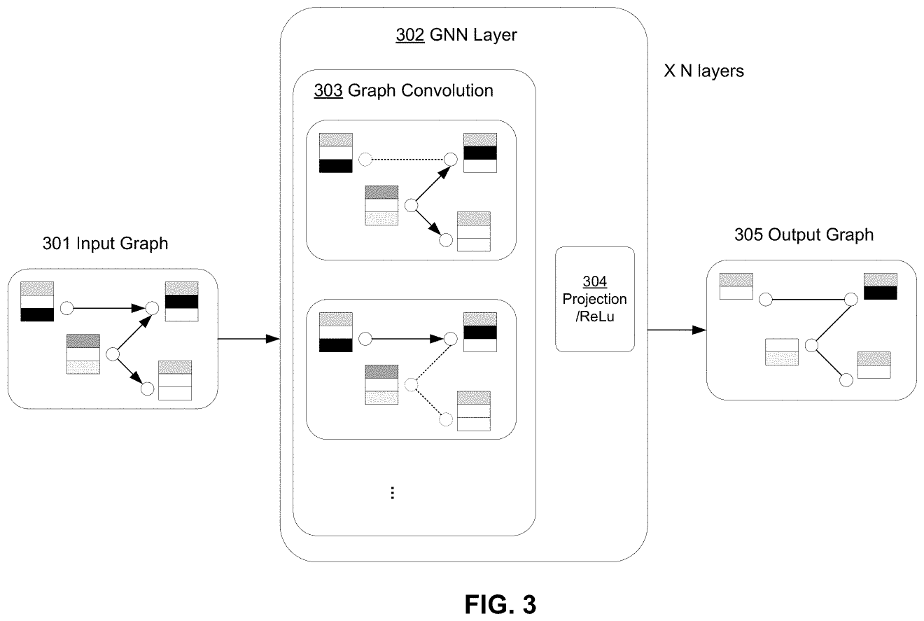

FIG. 3 illustrates exemplary graphic neural network (GNN) computations in accordance with some embodiments. GNNs have many sub-classes that may be designed for different application domains and involve different computation processes. For illustrative purposes and simplicity, the environment in FIG. 3 demonstrates a most dominant sub-class of GNNs focusing on graph convolution. The embodiments described in this specification are applicable to GNNs in general and are not limited to the convolutional GNN in FIG. 3.

The generic structure of the convolutional GNN in FIG. 3 involves an input graph 301, a GNN layer 302, and an output graph 305. In some embodiments, the input graph 301 may be represented as an adjacency matrix with rows and columns labeled by nodes in the input graph 301. In some embodiments, the values in the adjacency matrix may indicate whether a connection exists between the node corresponding to the row and the node corresponding to the column. In other embodiments, the non-zero values in the adjacency matrix may convey other proper meanings. In some embodiments, each node in the input graph 301 may be associated with a feature vector. The content and practical meanings of the feature vectors may differ depending on the use cases. The feature vectors of the nodes in the input graph 301 may be collectively represented as a feature matrix.

In some embodiments, the adjacency matrix and the feature matrix of the input graph 301 may be input to a sequence of convolutional GNN layers 302. FIG. 1 shows the first GNN layer 302 (right after the input layer) for illustrative purposes. The GNN layer 302 may be configured to perform graph convolution 303 and other operations 304 such as projection and rectified linear activation function (ReLu). During the graph convolution 303, the features of the nodes in the input graph 301 may be propagated and aggregated according to the underlying graph structure, i.e., the adjacency matrix of the input graph 301. For example, for a given node in the input graph 301, a computational graph of the given node may be determined based on the adjacency matrix to include the nodes connected to the given node. The features of the nodes in the computational graph may be aggregated using neural networks. The aggregated features may subsequently be projected onto a new subspace via a learned projection matrix. The resulting node features may then go through a nonlinear activation layer (ReLu) before eventually being transformed into an output graph 305. In a simplified denotation, the graph convolution 303 may be represented as Y=σ(AXW), where A refers to the adjacency matrix of the input graph 301, X refers to the feature matrix of the input graph 301, W refers to a weight matrix to be updated during the training process, and σ refers to a function that transforms the AXW to the output matrix representing the output graph 305.

During the training process, a loss function may be defined to quantify output graph 305. If the training is an unsupervised training, the loss function may be a loss based on node proximity in the graph or random walks. If the training is a supervised training, the loss function may be constructed based on the labels of the training data. During an inferencing process using the trained GNN, the input graph 301 may go through the same path through the plurality of GNN layers 302 and eventually be transformed into the output graph 305 with transformed node features.

In both training the GNN and making inferences using the trained GNN, the adjacency matrix of the input graph 301 is used throughout the process for computation. Since all the nodes in the adjacency matrix (i.e., all the nodes in the graph) are accessed during training and/or inferencing and the order of accessing makes no difference on the results, rearranging the values in the adjacency matrix would not affect the GNN computation. Embodiments described in this specification take advantage of this fact by preprocessing the input graph 301 into a plurality of tiles with different levels of sparsity (i.e., the number of non-zero values). These tiles may then be assigned to different hardware architectures for parallelly performing the matrix computations in training or inferencing.

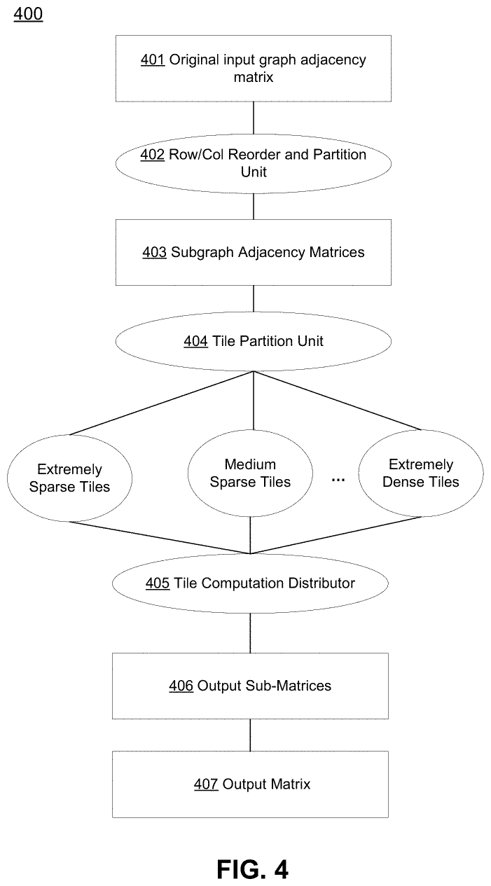

FIG. 4 illustrates an exemplary flowchart 400 of preprocessing an input graph for GNN computations in accordance with some embodiments. The flowchart 400 in FIG. 4 is for illustrative purposes only. Depending on the implementation, the flow chart 400 may include additional, fewer, or alternative steps performed in various orders or parallel. The method illustrates in the flowchart 400 may be implemented in the accelerator 230 of FIG. 1, the graph preprocessing core 238 of FIG. 2A and FIG. 2B. For example, the operations performed at step 402 in the flowchart 400 may be implemented as the matrix partitioning circuit 311 and the sub-matrix reordering circuit 312 of FIG. 2B, the operations performed at step 404 in the flowchart 400 may be implemented as the tile partitioning circuit 313 of FIG. 2B, and the operations performed at step 405 in the flowchart 400 may be implemented as the tile distributing circuit 314 of FIG. 2B,

In some embodiments, an original adjacency matrix representing an input graph of a GNN may be received at step 401. Before the original input graph adjacency matrix being used for GNN computations, it may be preprocessed to co-locate non-zero values and partitioned to fully exploit the performance optimizations offered by the underlying hardware architectures.

At step 402, a row/column reorder and partition unit may be configured to (1) partition the received adjacency matrix representing the input graph of a plurality of nodes into a plurality of sub-matrices based on feature similarities among the plurality of nodes, and (2) reorder rows and columns of each of the plurality of sub-matrices based on a number of non-zero values in each of the rows and columns.

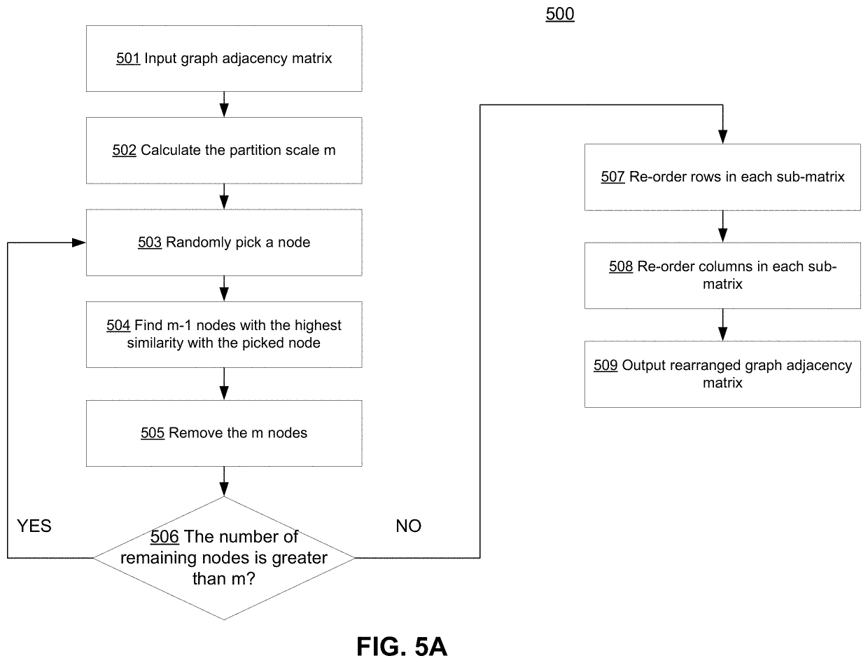

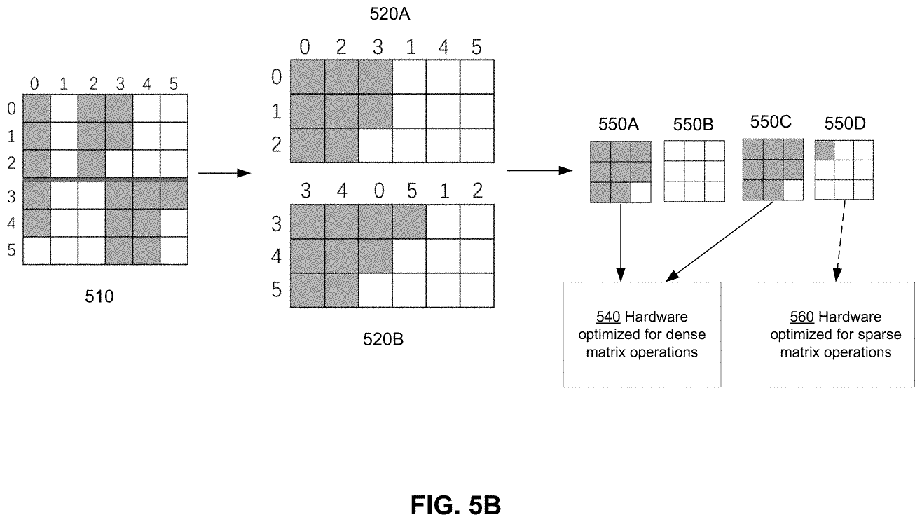

In some embodiments, the partitioning of the adjacency matrix into a plurality of sub-matrices comprises determining a number of sub-matrices to be partitioned from the adjacency matrix, determining a number of nodes m in each of the plurality of sub-matrices based on a total number of nodes in the graph and the number of sub-matrices, selecting a node from the graph, determining a plurality of feature similarity scores between the node and each different node in the graph, identifying, from the plurality of feature similarity scores, m−1 highest feature similarity scores corresponding to m−1 nodes; and constructing a sub-matrix based on rows of the adjacency matrix that correspond to the node and the m−1 nodes. Further details about the row and column reorder and partition unit at step 402 may refer to the description of FIG. 5A.

In some embodiments, each sub-matrix may include a plurality of rows representing a plurality of nodes with similar feature vectors. However, the non-zero values in each column of the sub-matrix may not be closely clustered (e.g., co-located). The row/column reordering phase in step 402 is designed to cluster the non-zero values within each sub-matrix close. After the row/column reordering, a plurality of fine-tuned sub-matrices may be obtained at step 403, which may be referred to as subgraph adjacency matrices.

At step 404, a tile partition unit may be configured to determine a data processing granularity of one or more processors that will perform graph neural network (GNN) computations. The one or more processors may be configured in different computation modes optimized for data sets with different levels of sparsity. Then the tile partition unit may be further configured to partition the plurality of sub-matrices with reordered rows and columns into a plurality of tiles based on the data processing granularity of the hardware processing entity, wherein the plurality of tiles each comprises a data set with a level of sparsity. Here, a “tile” refers to a rectangular portion of a sub-matrix. The “processor” refers to any type of processing unit in the computer technologies, such as CPU, GPU, TPU, NPU, another suitable processing unit, or any combination thereof. In some embodiments, configuring a processor in a computation mode may include implementing an acceleration library on the processor. The library may be a hardware and/or software acceleration library for a specific type of operation. For example, cuSPARSE library on GPU may yield great performance on sparse matrix computations. Other GPU acceleration libraries may be contemplated, such as cuBLAS, cuFFT, cuRAND may be used for optimizing computations involving matrices of different levels of sparsity.

Partitioning the sub-matrices into smaller tiles provides at least two folds of benefits for GNN computations. First, the size of each tile may be configured to fit the data processing granularity of the underlying hardware (i.e., the individual processor) to optimize resource utilization and simplify scheduling. For example, a Graphics Processing Unit (GPU) may have a warp size of 32. The “warp size” refers to the number of threads in a warp, which is a sub-division in the hardware implementation to coalesce memory access and instruction dispatch within a GPU. Assigning 32 by 32 tiles to GPUs may optimize the hardware resource usage through warp scheduling. Second, the tiles may be classified into different groups based on the levels of sparsity, and then be processed by corresponding hardware architectures or processors optimized for different levels of sparsity. As described above, after the row/column reordering and partitioning on the adjacency matrix, the resultant sub-matrices may have non-zero values clustered. Therefore, the smaller tiles partitioned from the sub-matrices may have different levels of sparsity. For example, some tiles may be sparse, some tiles may be medium sparse/dense, and the rest tiles may be dense. This differs from directly partitioning the original adjacency matrix into small tiles, which will most likely result in partially sparse/dense tiles (e.g., hard to control the levels of sparsity of the tiles).

At step 405, the tiles with different levels of sparsity may be distributed to processors through a tile computation distributor. These processors may be optimized for processing data sets with different levels of sparsity. In some embodiments, the optimization may be achieved by software libraries and/or hardware libraries, collectively called acceleration libraries. For example, CUDA Sparse Matrix (cuSPARSE) library is the best fit for processing data sets with a sparsity of over 90%, while CUDA Basic Linear Algebra Subprograms (cuBLAS) library may be applied to dense data sets. Processors equipped with different acceleration libraries may parallelly compute the tiles and generate output sub-matrices at step 406. These output sub-matrices may be aggregated into an output matrix at step 407. In some embodiments, the optimization may be achieved by using different types of processors.

The flow chart 400 in FIG. 4 is designed for preprocessing an adjacency matrix of an input graph. In some embodiments, similar preprocessing steps may also apply to a feature matrix of the input graph. For example, a row reordering (e.g., swapping row A and B) in the adjacency matrix may correspond to a column reordering (e.g., swapping column A and B) in the feature matrix, and a column reordering in the adjacency matrix may correspond to a row reordering in the feature matrix. In some embodiments, the preprocessing steps may include: receiving a feature matrix of the graph, wherein each node of the graph is represented as a feature vector in the feature matrix; partitioning the feature matrix into a plurality of sub-feature-matrices based on the partitioning of the adjacency matrix; and reordering rows and columns of each of the plurality of sub-feature-matrices based on the reordering of the rows and columns of the each of the plurality of sub-matrices.

FIG. 5A illustrates an exemplary flowchart 500 of partitioning and reordering an adjacency matrix in accordance with some embodiments. The flowchart 500 in FIG. 5A is for illustrative purposes only. Depending on the implementation, the flow chart 500 may include additional, fewer, or alternative steps performed in various orders or parallel. The flow chart 500 in FIG. 5A is designed for preprocessing an adjacency matrix of an input graph. In some embodiments, similar preprocessing steps may also apply to a feature matrix of the input graph. In some embodiments, the feature matrix of the input graph may be embedded within the adjacency matrix. In some embodiments, the method illustrated in the flowchart 500 may be implemented by the matrix partitioning circuit 311 and the sub-matrix reordering circuit 312 of FIG. 2B.

At step 501, an input graph adjacency matrix may be obtained. The input graph adjacency matrix represents a graph with a plurality of nodes and edges. Depending on the use case, the nodes and edges in the graph may have different practical meanings. For example, document citation relations may construct graphs with documents as the nodes. GNNs may then learn embeddings for words and documents. These approaches may be used for various Natural Language Processing (NLP) tasks such as text classification, sequence labeling, machine translation, relation, and event extraction.

At step 502, a partition scale m may be determined based on a total number of nodes n in the graph and a number of sub-matrices k to be obtained. The number of sub-matrices k may be specified based on empirical data. The partition scale m may be calculated as

$$m = \frac{n}{k} ,$$

which refers to the number of nodes (e.g., the number of rows) in each sub-matrices.

Steps 503 to 505 illustrate a process to obtain a sub-matrix. At step 503, a node may be randomly selected from the graph. At step 504, a plurality of feature similarity scores between the node and each different node in the graph may be determined. In some embodiments, each of the feature similarity scores between two nodes is determined based on a distance between two feature vectors of the two nodes. Based on the plurality of feature similarity scores, m−1 highest feature similarity scores corresponding to m−1 nodes may be selected. Then a sub-matrix may be constructed based on the m modes, i.e., the randomly selected node and the m−1 similar nodes. In some embodiments, the feature similarity score between two nodes may be determined based on a Hamming distance between the feature vectors of the two nodes. The hamming distance may be calculated based on the number of positions in the two feature vectors at which the corresponding values are different. Here, the feature vector of a node may include an n-dimensional vector of numerical features that represent.

The above operations are described from the perspective of the graph, which may be translated into matrix operations on the adjacency matrix. For example, a node in the graph may be represented by a feature vector and/or a row in the adjacency matrix rows of the adjacency matrix. Constructing the sub-matrix may involve swapping rows of the adjacency matrix so that the rows correspond to the m nodes are placed together. After a sub-matrix is constructed, the m nodes may be removed from the graph before the next sub-matrix is constructed.

At step 506, a check may be performed to determine whether the graph has enough nodes to construct another sub-matrix. If yes, steps 503 to 505 may be repeated. If no, the partitioning phase of the adjacency matrix is complete. In some embodiments, the remaining nodes in the graph (less than m) may be abandoned for efficiency. These sub-matrices may have similar nodes in the graphs (i.e., similar rows in the adjacency matrix) rearranged together. However, the non-zero values in each sub-matrix may not be co-located.

Steps 507 and 508 involves row and column reordering in each of the sub-matrices to co-locate the non-zero values as much as possible. In some embodiments, the rows and columns of each of the plurality of sub-matrices may be reordered based on a number of non-zero values in each of the rows and columns. The number of “non-zero values” in each row or column may be referred to a degree of the row or column. The rows and the columns may be reordered based on their corresponding degrees in descending order.

At step 509, a rearranged graph adjacency matrix may be obtained. The flow chart 500 may be implemented as a preprocessing step that prepares the adjacency matrix before using it for performing GNN computations. This preprocessing step may transform the adjacency matrix and/or the feature matrix into a more hardware-friendly form.

FIG. 5B illustrates an example diagram of preprocessing an input graph for GNN computations in accordance with some embodiments. The input graph may be represented as an adjacency matrix. For illustrative purposes, in FIG. 5B, the boxes in grey refer to non-zero values, and the boxes in white refer to zero values. In some embodiments, the data flows and operations illustrated in the diagram of FIG. 5B may be implemented by the tile partitioning circuit 313 and the tile distributing circuit 314 of FIG. 2B.

The matrix 510 in FIG. 5B may refer to an adjacency matrix that is partitioned into two sub-matrices through steps 503-505 in FIG. 5A. As shown, rows 0-2 of the matrix 510 belong to the first sub-matrix and rows 3-5 belong to a second sub-matrix. The rows within each sub-matrix have high similarities. For example, they share similar distributions of the non-zero values.

Subsequently, the two sub-matrices may go through row and column reordering and become two re-arranged sub-matrices 520A and 520B. The reordering may order the rows and/or columns based on the number of non-zero values therein. For example, to obtain the re-arranged sub-matrix 520A, the columns 2 and 3 are moved towards the left so that the non-zero values are co-located. Similarly, to obtain the re-arranged sub-matrix 520B, columns 0, 3, 4, and 5 are moved towards the left to co-locate the non-zero values. In some embodiments, the columns may be sorted based on the number of non-zero values and reordered accordingly. For example, columns 3 and 4 of sub-matrix 520B with the most number of non-zero values (highest degrees) are placed to the leftmost position.

The two re-arranged sub-matrices 520A and 520B are then partitioned into smaller tiles 530A-530D. The tiles may refer to the smallest data set unit to be processed by the underlying processors. In some embodiments, the size of the tiles may be determined based on the data processing granularity of the underlying processors. For example, the data processing granularity may be determined by the number of threads supported by a basic unit of execution in a processor (e.g., warp in GPU).

As shown in FIG. 5B, the tiles 530A and 530C may be classified as dense, i.e., with a large number of non-zero values. Therefore, these two tiles may be assigned to the hardware optimized for dense matrix operations 540. The tile 530B has all zero values, and thus may be abandoned to save computational resources.

The tile 530D has a few number of non-zero values and may be classified as sparse. It may be assigned to processors optimized for sparse matrix operations 550 (e.g., GPU using cuSPARSE library). In some embodiments, some sparse tiles may be abandoned to save computational resources at the cost of nominal accuracy loss. For example, if the level of sparsity of a tile is less than a threshold, it may be excluded from being assigned to the underlying hardware for computation.

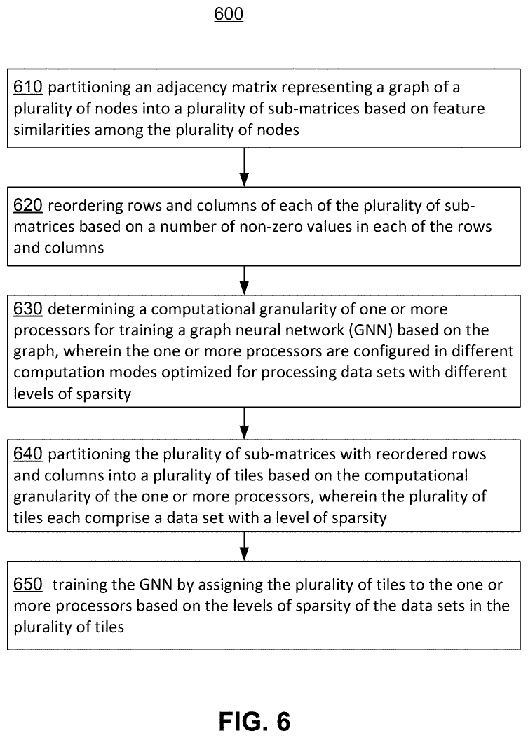

FIG. 6 illustrates an exemplary method 600 of accelerating GNN computations with adjacency matrix preprocessing in accordance with some embodiments. The method 600 may be implemented in an environment shown in FIG. 1. The method 600 may be performed by a device, apparatus, or system illustrated by FIGS. 1-5B, such as the accelerator 230, the graph preprocessing core 238, or the circuits 311-314 within the graph processing core. Depending on the implementation, the method 600 may include additional, fewer, or alternative steps performed in various orders or parallel.

Block 610 includes partitioning an adjacency matrix representing a graph of a plurality of nodes into a plurality of sub-matrices based on feature similarities among the plurality of nodes. In some embodiments, each of the feature similarities among the plurality of nodes is determined based on a distance between two feature vectors representing two of the plurality of nodes in the graph. In some embodiments, the distance is a hamming distance. In some embodiments, the partitioning the adjacency matrix into a plurality of sub-matrices comprises: determining a number of sub-matrices to be partitioned from the adjacency matrix; and determining a number of nodes m in each of the plurality of sub-matrices based on a total number of nodes in the graph and the number of sub-matrices. In some embodiments, the partitioning the adjacency matrix into a plurality of sub-matrices further comprises: selecting a node from the graph; determining a plurality of feature similarity scores between the node and each different node in the graph; identifying, from the plurality of feature similarity scores, m−1 highest feature similarity scores corresponding to m−1 nodes; and constructing a sub-matrix based on rows of the adjacency matrix that correspond to the node and the m−1 nodes. In some embodiments, prior to constructing another sub-matrix, removing the node and the m−1 nodes from the graph.

Block 620 includes reordering rows and columns of each of the plurality of sub-matrices based on a number of non-zero values in each of the rows and columns

Block 630 includes determining a data processing granularity of one or more processors for GNN computations, wherein the one or more processors are configured in different computation modes optimized for data sets with different levels of sparsity. In some embodiments, the one or more processors comprise a graphic processing unit (GPU), and one of the one or more computation modes uses a Compute Unified Device Architecture (CUDA) Sparse Matrix (cuSPARSE) library.

Block 640 includes partitioning the plurality of sub-matrices with reordered rows and columns into a plurality of tiles based on the data processing granularity of the one or more processors, wherein the plurality of tiles each comprise a data set with a level of sparsity.

Block 650 includes assigning the plurality of tiles to the one or more processors based on the levels of sparsity of the data sets in the plurality of tiles.

In some embodiments, the method 600 may further include: identifying one or more of the plurality of tiles upon each with a number of non-zero values less than a threshold, wherein the assigning the plurality of tiles to the one or more computational systems comprises: assigning, to the one or more computational systems, the plurality of tiles excluding the one or more identified tiles.

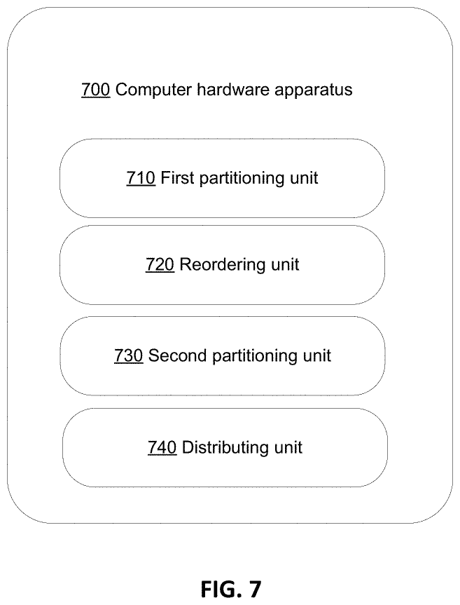

FIG. 7 illustrates a block diagram of a computer system apparatus for accelerating GNN computation with adjacency matrix preprocessing in accordance with some embodiments. The components of the computer system apparatus 700 presented below are intended to be illustrative. Depending on the implementation, the computer system apparatus 700 may include additional, fewer, or alternative components.

The computer system apparatus 700 may be an example of implementing the method of FIG. 6. The computer system apparatus 700 may include one or more processors and one or more non-transitory computer-readable storage media (e.g., one or more memories) coupled to the one or more processors and configured with instructions executable by the one or more processors to cause the system or device (e.g., the processor) to perform the above-described embodiments. The computer system apparatus 700 may include various units/modules corresponding to the instructions (e.g., software instructions).

In some embodiments, the computer hardware apparatus 700 may be referred to as an apparatus for accelerating GNN computations by preprocessing the adjacency matrix of the input graph. The computer hardware apparatus 700 may include a first partitioning unit 710, a reordering unit 720, a second partitioning unit 730, and a distributing unit 740. These units may be implemented by the hardware devices and electronic circuits illustrated in FIGS. 1-6.

In some embedment's, the first partitioning unit 710 may be configured to partition an adjacency matrix representing a graph of a plurality of nodes into a plurality of sub-matrices based on feature similarities among the plurality of nodes. The reordering unit 720 may be configured to reorder rows and columns of each of the plurality of sub-matrices based on a number of non-zero values in each of the rows and columns The second partitioning unit 730 may be configured to partition the plurality of sub-matrices with reordered rows and columns into a plurality of tiles based on processing granularities of one or more processors. The distributing unit 750 may be configured to distribute the plurality of tiles to the one or more processors for performing the GNN computations.

Each process, methods, and algorithms described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A hardware accelerator for accelerating Graph Neural Network (GNN) computations, comprising:
a matrix partitioning circuit configured to partition an adjacency matrix of an input graph for GNN computations into a plurality of sub-matrices;
a sub-matrix reordering circuit configured to reorder rows and columns of the plurality of sub-matrices;
a tile partitioning circuit configured to divide the plurality of sub-matrices with reordered rows and columns into a plurality of tiles based on processing granularities of one or more processors; and
a tile distributing circuit configured to distribute the plurality of tiles to the one or more processors for performing the GNN computations.

2. The accelerator of claim 1, wherein the sub-matrix reordering circuit is further configured to reorder the rows and the columns of the plurality of sub-matrices based on a number of non-zero values in each of the rows and the columns

3. The accelerator of claim 1, wherein the one or more processors for performing the GNN computations are configured in different computation modes optimized for processing data sets with different levels of sparsity.

4. The accelerator of claim 3, wherein the one or more processors comprise a graphic processing unit (GPU).

5. The accelerator of claim 4, wherein one of the different computation modes comprises a Compute Unified Device Architecture (CUDA) Sparse Matrix (cuSPARSE) library.

6. The accelerator of claim 4, wherein one or more of the plurality of tiles have a size determined based on a warp size of the GPU.

7. The accelerator of claim 3, wherein each of the plurality of tiles comprises a data set with a level of sparsity, and
the tile distributing circuit is further configured to distribute each of the plurality of tiles to one of the one or more processors in a computation mode optimized for processing data sets with the level of sparsity.

8. The accelerator of claim 1, wherein the input graph comprises a plurality of nodes with corresponding feature vectors, and the matrix partitioning circuit is further configured to partition the adjacency matrix based on distances among the feature vectors of the plurality of nodes in the input graph.

9. The accelerator of claim 8, wherein the distances among the feature vectors comprise hamming distances among the feature vectors.

10. The accelerator of claim 1, wherein the matrix partitioning circuit is further configured to:
determine a number of sub-matrices to be partitioned from the adjacency matrix;
determine a number of nodes m in each of the plurality of sub-matrices based on a total number of nodes in the input graph and the number of sub-matrices; and
partition the adjacency matrix of the input graph into the plurality of sub-matrices each comprising m nodes.

11. The accelerator of claim 10, wherein the matrix partitioning circuit is further configured to: select a node from the input graph;
determine a plurality of feature similarity scores between the node and other nodes in the input graph;
identify m−1 of the other nodes with highest feature similarity scores; and construct a sub-matrix based on rows of the adjacency matrix that correspond to the node and the m−1 nodes.

12. The accelerator of claim 10, wherein the matrix partitioning circuit is further configured to remove the node and the m−1 nodes from the input graph prior to constructing another sub-matrix.

13. The accelerator of claim 1, wherein the tile distributing circuit is further configured to:
discard one of the plurality of tiles with a level of sparsity less than a non-zero threshold value.

14. A computer system, comprising:
an interconnect;
one or more accelerators;
one or more processors coupled to the one or more accelerators through the interconnect, the one or more accelerators configured to:
partition an adjacency matrix of an input graph for GNN computations into a plurality of sub-matrices;
reorder rows and columns of the plurality of sub-matrices;
divide the plurality of sub-matrices with reordered rows and columns into a plurality of tiles based on data processing granularities of the one or more processors; and
distribute the plurality of tiles though the interconnect to the one or more processors.

15. The computer system of claim 14, wherein the one or more accelerators are further configured to reorder the rows and the columns of the plurality of sub-matrices based on a number of non-zero values in each of the rows and the columns.

16. The computer system of claim 14, wherein the one or more processors are configured in different computation modes optimized for processing data sets with different levels of sparsity, and
the one or more accelerators are further configured to:
determine a level of sparsity of a data set in each of the plurality of tiles; and
distribute the each tile to one of the one or more processors in a computation mode optimized for processing data sets with the level of sparsity.

17. The computer system of claim 16, wherein the one or more processors comprise a graphic processing unit (GPU), one of the different computation modes comprises a Compute Unified Device Architecture (CUDA) Sparse Matrix (cuSPARSE) library, and one or more of the plurality of tiles have a size determined based on a warp size of the GPU.

18. The computer system of claim 14, wherein the one or more accelerators are further configured to:
determine a number of sub-matrices to be partitioned from the adjacency matrix;
determine a number of nodes m in each of the plurality of sub-matrices based on a total number of nodes in the input graph and the number of sub-matrices;
select a node from the input graph;
determine a plurality of feature similarity scores between the node and other nodes in the input graph;
identify m−1 of the other nodes with highest feature similarity scores; and
construct a sub-matrix based on rows of the adjacency matrix that correspond to the node and the m−1 nodes.

19. The computer system of claim 14, wherein the one or more accelerators are further configured to discard one of the plurality of tiles with a level of sparsity less than a non-zero threshold value.

20. A computer-implemented method for accelerating Graph Neural Network (GNN) computations, comprising:
partitioning an adjacency matrix of an input graph for GNN computations into a plurality of sub-matrices;
reordering rows and columns of the plurality of sub-matrices;
dividing the plurality of sub-matrices with reordered rows and columns into a plurality of tiles based on processing granularities of one or more processors; and
distributing the plurality of tiles to the one or more processors for performing the GNN computations.
